(19) United States
(12) Patent Application Publication
(10) Pub. No.: US 2026/0175260 A1
(43) Pub. Date: Jun. 25, 2026

(54) SIEVE DEVICE FOR PLANSIFTERS FOR FRACTIONATING GROUND CEREAL PRODUCTS

(71) Applicant: Swisca AG, Appenzell (CH)

(72) Inventors: Oliver Ensslin, Appenzell (CH); Jonas Schär, Appenzell (CH)

(21) Appl. No.: 19/125,415

(22) PCT Filed: Nov. 6, 2023
(86) PCT No.: PCT/EP2023/080858

§ 371 Date: Apr. 29, 2025

(30) Foreign Application Priority Data
Nov. 7, 2022 (CH) CH001319/2022

(51) Int. Cl. B07B 1/46; A01F 12/44; B07B 1/38; B07B 1/54

(52) U.S. Cl. CPC B07B 1/46; A01F 12/448; B07B 1/38; B07B 1/54; B07B 2201/04

(57) ABSTRACT

A plansifter includes at least one sieve compartment with an arrangement of several sieve devices with sieves. The sieve device includes a sieve frame and an insert frame with the sieve which is fastened thereon. The sieve frame forms a circumferential side wall and an inwardly projecting rest, on which the insert frame lies, such that the sieve lies within the circumferential side wall. The circumferential side wall surrounds the sieve at the outer side, along an outer delimitation (edge or the like) of the sieve. The sieve lies below an upper edge of the circumferential side wall. The sieve frame thus forms a trough in which the insert frame with the sieve lies.

### BACKGROUND OF THE INVENTION

### Field of the Invention

The invention relates to machines, for example plansifters, as are applied for fractionating ground cereal products. In particular, it relates to a sieve device for a plansifter.

### Description of Related Art

Plansifters serve for the separation of constituents of a ground product into coarser or finer grained constituents and under certain circumstances also into constituents of different densities, as well as for the removal of foreign bodies from the ground product. The separating of the ground product into differently grained constituents is also denoted as “grading” or “fractionating”. Plansifters are generally used in the milling industry for fractionating ground cereal products between and after passages through the roller mill of a cereal mill. They can also be applied for so-called control sifting, i.e. sieving of flour which per se is ready for sale.

Plansifters include sieve compartments which each include a stack of plane sieves and are brought into horizontal oscillatory movements, in particular into circular oscillations in the sieve plane by way of a suitable drive mechanism. The sieves are each spanned on primary frames, so-called “insert frames” which for their part are inserted in sieve frames (denoted here as “secondary frames”). Seals, for example of a suitable felt, are each present on the plane of the sieve mesh between sieve frames which lie on one another and are to prevent the product from exiting laterally in an undesired manner. The seals however are subject to deterioration by way of compression and have to be renewed again and again. Moreover, the height of the insert frame and the height of the structures in the sieve frame, in which structures the insert frames are led, need to be matched very well to one another, so that the insert frame sits well and is well sealed on stacking. A further disadvantage of felt seals results from the fact that a felt seal is built in between the sieve frames each time. Usually, roughly 20-30 sieve frames are stacked upon one another. The sieve frames are pressed on one another in the stack. By way of this, the felt seals are compacted over time and their height is reduced. Herein, they usually lose up to half their original thickness. This leads to the uppermost sieve frames being displaced in their position downwards by up to a few centimetres. This in turn can lead to their position no longer being correct with respect to schematic parts in the sifter wall.

A further issue relates to the spatial requirements. There is the constant need to maximise the sieve performance per taken-up volume. An optimised height per sieve device or a compact as possible arrangement of sieve stacks next to one another can be desirable here.

Common plansifters require a so-called sieve box around the sieve stacks, which firstly entails certain disadvantages with regard to the spatial requirements and secondly also renders the handling somewhat more difficult, not least due to the fact that usually complete preassembled sieve box rows or drive modules are transported as preassembled units.

Yet an issue is the compatibility. Plansifters of different generations are often present in milling facilities. For the operator of a milling facility, it can be unfavourable to have to keep a stock with the most important consumable parts—specifically the sieves—for each plansifter or different groups of plansifters. For this reason, a desirable characteristic of sieve devices can be for sieves which can also be used in other, older plansifters to also be able to be applied. In particular, the principle of fastening a sieve to a primary frame which given damage to the sieve can be exchanged together with the sieve can be a desirable characteristic.

US 2009/0184031 A1 discloses a sieve with a rectangular container for use in a canteen. After the flouring or powdering of foodstuffs, the reusable flour/powder is to be able to be sieved into the container with this sieve. Such a sieve is neither envisaged for a plansifter nor would it be suitable for such, not least because the sieve must be movable relative to the container and for which reason the necessary horizontally oscillating movements would not be able to be coupled into it at all.

FR 2023574 shows a plansifter with sieve compartments which include drawers, into which sieve frames with spanned sieves are pushed. The drawers are formed by rails which run on two opposite sides of the sieve frame.

### SUMMARY OF THE INVENTION

It is an object of the present invention to provide a sieve device for a plansifter as well as a plansifter which allows for improvements at least with regard to one or more of the aforementioned issues. In particular, the sieve device should be robust and be able to be used in a flexible manner and preferably at least permit the use as open sieve stacks without the necessity of a sieve box.

According to an aspect of the present invention, a sieve device for plansifters is provided, the sieve device including a sieve frame and an insert frame with a sieve which is fastened thereon, in particular spanned thereon, wherein the sieve frame includes a circumferential side wall and an inwardly projecting rest, on which the insert frame lies, and specifically such that the sieve lies within the circumferential side wall—i.e. the circumferential side walls surrounds the sieve at the outer side, along an outer delimitation (edge or the like) of the sieve and of the insert frame. Furthermore, the sieve lies below an upper edge of the circumferential side wall.

The sieve frame therefore quasi forms a trough, in which the insert frame lies with the sieve.

On the one hand, this has the advantage that the position of the insert frame with the frame is defined without constraint. In particular, the circumferential side wall and the insert frame are matched to one another such that the insert frame is received in the trough which is formed by the sieve frame, essentially in a precisely fitting and for example play-free manner.

In particular, the insert frame is immovable relative to the sieve frame with respect to horizontal directions on account of the mentioned precision fit and/or by way of a clamping frame which clamps the insert frame against the sieve frame.

Secondly, an advantage with regard to the sealing results: according to the state of the art, one needs to seal at the plane of the sieve between the sieve device and the sieve device which lies above this. Although this is possible by way of suitable seals, it is however not completely unproblematic, not least due to the fact that the plane of the sieve is that plane in which the hydrostatic pressure is largest (if the sieving product is characterised approximately as a fluid)—the seal therefore needs to take its effect against the hydrostatic pressure of the sieving product. In contrast to this, concerning the procedure according to the invention, sieving product cannot escape laterally due to the circumferential side wall. The action of a labyrinth seal results to combat an escape externally past the insert frame, without further measures. For this purpose, the rest can run in an interrupted manner in particular along the circumference of the insert frame, i.e. the insert frame in particular lies on the rest along its complete circumference.

Thirdly, the procedure according to the invention also permits a design which is advantageous with regard to the ratio between the height of the sieve device on the one hand and the cross-sectional area of the lateral opening (slot opening) on the other hand. As is known per se, the sieve device can include a collection base below the sieve, the collection base being formed for example by the sieve frame. The collection base delimits a collection region to the bottom below the sieve, wherein the collection region is open to at least one side by way of the sieve device including the mentioned slot opening, through which the throughs (the sieving product which gets through the sieve) can be led away. The efficiency of the sieving procedure depends not least on the size of this slot opening. The design according to the invention permits the use of a particularly flat insert frame, by way of which the ratio between the height of the slot opening and the height of the complete sieve device can be particularly favourable. The height of the slot opening can therefore be at the most 20%, in particular at the most 15% smaller than the distance between the collection base and the sieve. Supplementarily or alternatively, the condition of the height of the slot opening being smaller than the distance between the collection base and the sieve by at the most the thickness of the insert frame plus the thickness of an inwardly projection which is formed for example by an intermediate sheet, can be fulfilled.

In particular, the collection base can form the closure of the sieve frame to the bottom, i.e. the collection base can be arranged completely on the lower side of the sieve frame, and the sieve frame thus be free of walls or other structures which projects downwards from the level of the collection base (possibly with the exception of small projections which form the stack structures which are yet described hereinafter).

This means that an inlet region above the sieve, between the sieve and the collection base of the sieve device lying thereabove, is formed completely by the trough-like structure which arises on the one hand by the sieve and on the other hand by an upper portion of the circumferential side wall (possibly together with the clamping frame, see subsequent description). The trough-like structure which is formed by the sieve frame therefore receives the sieving product which hits the sieve from above.

The collection base below the sieve in particular can be formed by the sieve frame. It can be metallic and/or particularly thin, by way of it having a thickness of at the most 3 mm, in particular at the most 2 mm and for example roughly 1 mm. The collection base together with the side wall can be formed by sheet pieces or possibly by way of a suitable folded sheet.

The circumferential side wall can be constructed of several wall elements. For example, if they are metallic, then such wall elements can be of sheet and the resulting intermediate spaces between surface sections, i.e. between wall elements or possibly between surface sections which result from the folding of a sheet wall element, can be filled with a thermally insulating material in order to combat a condensation on inner surfaces of the side wall.

An intermediate base-possibly present as a sheet piece—can form the rest.

The circumferential side wall can receive through-channels, wherein one row, two rows or even no rows of through-channels can be present per side depending on the configuration.

Through-channels are very generally vertical channels which are laterally present on the sieve frame and through which sieving product can fall downwards into a sieve frame which lies next below or into a discharge conduit.

The sieving product which falls through the through-channels then gets from these either onto a sieve of the (accordingly differently configured) sieve device which lies therebelow or into a through-channel of the sieve device which lies therebelow or possibly into a discharge conduit. Through-channels which simply let through the sieving product from the next upper to the next lower sieve device without a lateral slot opening are also called “drop channels” here. The lateral slot opening through which the sieving product is transported away from the collection region in particular runs out into one of the through-channels.

In embodiments, the sieve device includes at least one sieve cleaner i.e. an element which is movable relative to the sieve and which on account of the movements of the sieve is subjected to movements which are more or less random. As is known per se, such a sieve cleaner can move on the collection base, wherein the height of the sieve cleaner is only a little less than the height of the collection region, which is why it abuts with its movements again and again on the sieve. Since—as described above—the height of the lateral slot opening(s) can be relatively large, the collection base can include restraining structures, for example in the form of thin pins which limit the movements of the sieve cleaner to a desired region—in particular they can prevent the sieve cleaner from getting through the slot opening or becoming jammed in this.

Alternatively to at least one sieve cleaner or supplementarily to this, the collection region can also include one or more obstacles which encourages/encourage a transport of the throughs through the lateral slot opening in the collection region.

The rest at least in regions—for example with the exception of the side(s) which comprises/include the slot opening—can be formed as a shoulder of the circumferential side wall.

The insert frame can be metallic—for example it can be designed as a metallic flat body (thin plate) with at least one large-surfaced recess over which the sieve is spanned. The insert frame for example can include an outer frame part which as a whole is essentially rectangular, with dimensions which are adapted to the rest. Apart from the outer frame part, a system of rods with at least one rod which in cross section is for example rectangular and over which the sieve is spanned can also be present for stabilising the sieve.

The insert frame can be comparatively thin, with a thickness for example of 3 mm at the most.

The sieve can be designed as a flat body, in particular as a metal sheet with sieve openings as through-holes. If the sieve has a matching material (for example if the insert frame as well as the sieve is metallic) then the sieve can be welded to the insert frame.

A “flat body” is a foil or sheet, i.e. a continuous object which extends in two dimensions with an in particular constant thickness (extension in the third dimension) which is smaller by at least one order of magnitude than the extensions in the two other dimensions (length and width). Depending on the thickness, such a flat body tends to be perceived more as a foil or as a sheet. As is described in detail in the patent application CH 000837/2022, it has been surprisingly found that the design as a flat body with through-holes-instead of a mesh of filaments and wires as is known from the state of the art-significantly improves the effectiveness. The time which is necessary in order to bring a certain quantity of sieving product (flour, wheat middlings, semolina, grit etc.) through a defined sieve area can be significantly reduced, with all other relevant parameters (mechanical excitation, size of the sieve holes, number of sieve holes) being equal.

It has also been found that such sieves which are designed as flat bodies are particularly advantageous in combination with features of the present invention.

For example, the aforedescribed sealing effect due to the trough is particularly advantageous due to the large mobility of the sieving product on such flat body sieves, and an enlarged slot opening in relation to the sieve device height optimally interacts with the improved sieve effectiveness (sieving performance).

However, with regard to the construction according to the invention, sieves with filaments (threads/wires) of plastic, for example nylon sieves, can also be used without further ado. A further advantage of the procedure according to the invention is the fact that the thickness of the insert frame with the sieve is not set by the design of the sieve frame (it is solely the height of the clamping frame which needs to be possibly adapted, see below). For this reason, different sieves can be applied in a flexible manner in a milling facility and under certain circumstances in one and the same plansifter.

Apart from the sieve frame and the insert frame, the sieve device in embodiments also includes a clamping frame. The clamping frame is arranged such that the insert frame is fixed between the rest and the clamping frame. The clamping frame can fit into the receiver in an exactly matching manner, said receiver forming within an upper portion (above the rest) of the circumferential side wall.

In embodiments, the clamping frame can be shaped ‘such that the inner surface is flush with the inner surface of the lower portion (below the clamping frame) of the circumferential side wall. Supplementarily or alternatively, the clamping frame at the upper side can be flush with the upper edge of the circumferential side wall, i.e. its height can correspond to the height of the upper portion of the circumferential side wall, minus the thickness of the insert frame.

The clamping frame for example can have the shape of a rectangular profile.

The clamping frame can also possibly be metallic, possibly with a thermally insulating filling material.

In a group of embodiments, the sieve device at the upper side includes an upper-side stack structure and at the lower side a lower-side stack structure at the identical horizontal position (x-y position if a coordinate system whose z-axis corresponds to the vertical is defined), wherein the upper-side stack structure and the lower-side stack structure are matched to one another such that on stacking several of the sieve devices, the upper sieve device is defined in its horizontal position relative to the lower sieve device. Herein, the upper-side stack structure includes a first ramp, and the lower-side stack structure a second ramp, wherein the first and the second ramp are in contact with one another in a force-transmitting manner when a lower and an upper sieve device are stacked onto one another.

A ramp in the context of the present text is formed by a surface section which in regions is flat and is inclined to the horizontal and to the vertical.

By way of the first and the second ramp contacting one another in a force-transmitting manner, the upper sieve device is not only supported with respect to the lower sieve device on which it lies, but is also aligned in its horizontal position, and specifically without groove-rib structures which are matched to one another in an exactly fitting manner and which have the aforementioned disadvantages having to be present. Apart from this, there is also an advantage with regard to the sealing effect, in particular in combination with the principle which is yet described hereinafter, of providing the sieve in a manner fastened onto a insert frame, said insert frame being inserted into a trough-like structure of the sieve frame, which is why the ramps which lie on one another are not arranged at the sieve plane, but above this.

In particular, one can envisage the upper sieve device only lying on ramps (oblique surfaces) of the lower sieve device and therefore there being no horizontal surfaces which lie on one another in a force-transmitting manner.

In particular, the first ramp can be descending to the outside and the second ramp descending to the inside. It has been found that a further problem can be solved in this manner: the sieve device can be removed from a stack by way of it being slightly lifted at one side and then being pulled in the direction of this side (assuming that there are no sieve devices which lie thereabove and which with their complete weight lie on the sieve device to be removed), and specifically in a tool-free manner in many embodiments. This is a substantial advantage since sieve stacks are often not so easily accessible to the same extent from all sides

It is particularly favourable if the first ramp and the second ramp have an angle of between 25° and 65°, in particular between 30° and 50° to the horizontal.

Apart from the first and the second ramp, the upper-side stack structure can also include an upper-side, inwardly descending third ramp and the lower-side stack structure a lower-side outwardly descending fourth ramp, wherein the inclinations of the third and fourth ramp likewise correspond to one another (they can correspond to the inclination of the first and second ramp, but this does not need to be the case).

The clamping frame can possibly form the third ramp or a region (part) thereof, by way of it including a bevelling at the upper and inner side

Additionally to the sieve device, the present invention also relates to a plansifter with at least one stack of sieve devices of the type which is described here, additionally to a drive mechanism which brings this stack into horizontally oscillating movements, for example circular movements.

### BRIEF DESCRIPTION OF THE DRAWINGS

Embodiment examples of the invention are described hereinafter by way of drawings. In the drawings, the same reference numerals denote equal or analogous elements. The drawings show elements which partly correspond to one another in sizes which differ from figure to figure. There are shown in:

FIG. 1: a view of a plansifter with closed sieve compartments;

FIG. 2: a plansifter with open sieve stacks;

FIG. 3: an exploded representation of a sieve device with a sieve, primary frame, clamping frame and insert frame;

FIG. 4: a view of two sectioned sieve devices which are stacked on one another;

FIG. 5 the sieve devices of FIG. 4 in a plan view, front elevation and side elevation;

FIG. 6 a detail of FIG. 5 represented in an enlarged manner; and

FIG. 7 a schematic sectioned representation of an edge region of two sieve devices with is stacked onto one another, with sieve cleaners.

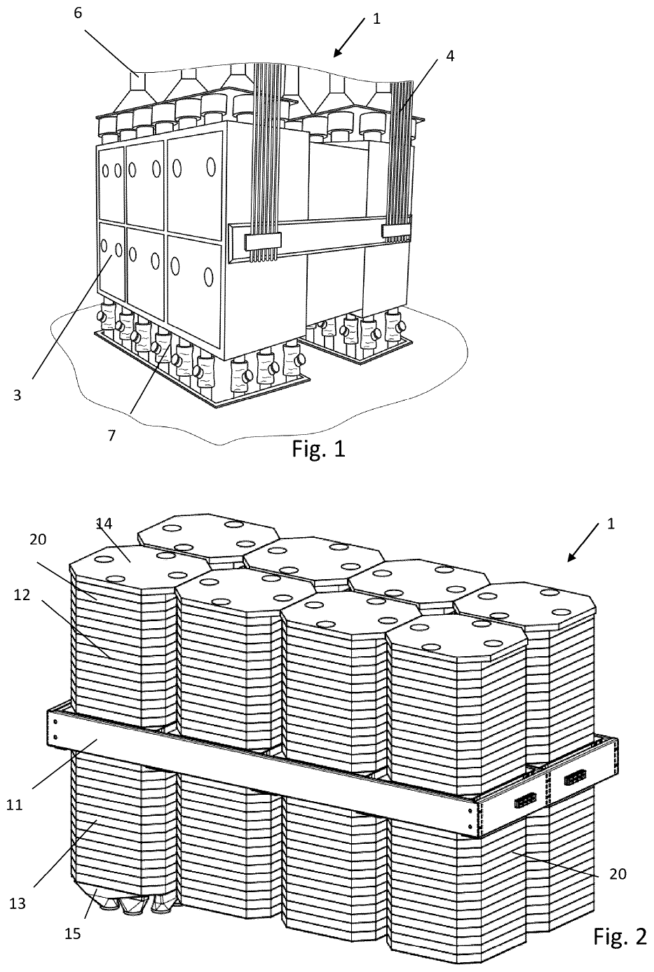

FIG. 1 shows a plansifter 1 as is applied in cereal mills. The plansifter includes a plurality of sieve compartments which via a common suspension device 4 are assembled in a space such that common horizontally oscillating movements are possible. A drive (not visible in FIG. 1) is configured to bring the ensemble of sieve compartments into for example horizontally circling oscillations. Furthermore, the plansifter includes flexible feed conduits 6 as a sieving product inlet, as well as likewise flexible outlet conduits 7 as a sieving product outlet. Each sieve compartment includes a stack of sieve devices which are arranged above one another. In the embodiment of FIG. 1, the sieve compartments are present in sieve boxes 3 which each form a housing for the sieve compartments. In such embodiments, the sieve devices which lie over one another in a stack-like manner are led and under certain circumstances also held, by way of suitable structures of the housing.

As an alternative to sieve compartments which are present in sieve boxes 3, sieve compartments can also be formed by open sieve stacks, concerning which a housing which surrounds a sieve stack is done away with.

FIG. 2 shows an embodiment example of such a plansifter with open sieve stacks in a particularly space-saving arrangement, wherein some elements (suspension device, feed conduits, partly outlet conduits) are not represented. A mount 11 serves as a mechanical carrier structure. A carrier frame for the upper sieve stacks 12 and the lower sieve stack 13 is formed, and in the represented embodiments also receives the drive modules which are not visible in the figure. The sieve stacks are fastened to the mount 11 in a direct or indirect manner, for example by way of a clamping system of rods and/or straps and/or other means; the clamping system is not represented in FIG. 2.

Drive modules for a modular construction which can be received in a mount 11 of the type which is drawn in FIG. 2 are described in the Swiss patent application 000722/2022. However, the present invention is independent of the design of the plansifter drive and also functions for plansifters with a central drive device as are often to be found, and as are present centrally between the sieve bodies 3 as in a plansifter of the type which is drawn in FIG. 1.

The upper sieve stack 12 and the lower sieve stack 2 in FIG. 2 are each formed from a multitude of sieve devices 20 of the type described hereinafter, wherein the sieve devices are stacked on one another in a direct manner, and wherein yet a closure element 14 and 15 is present at the upper side on the upper sieve stack 12 and at the lower side on the lower sieve stack respectively, by way of which element sieving product is fed and discharged. The sieves can have different mesh widths and the configuration of the sieve stacks can each be selected by the user in accordance with requirements. A plansifter with closed sieve compartments as is represented in FIG. 1 can also include sieve devices 20 according to the subsequent description.

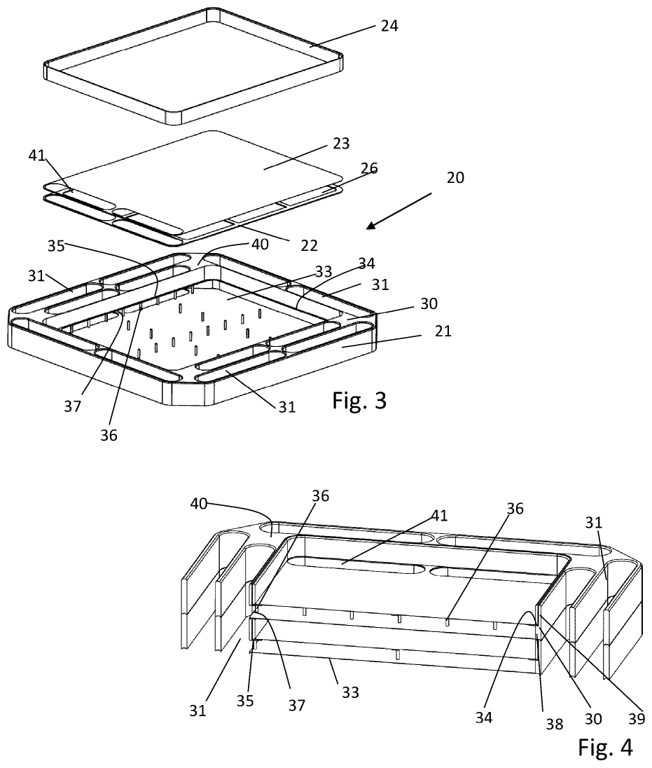

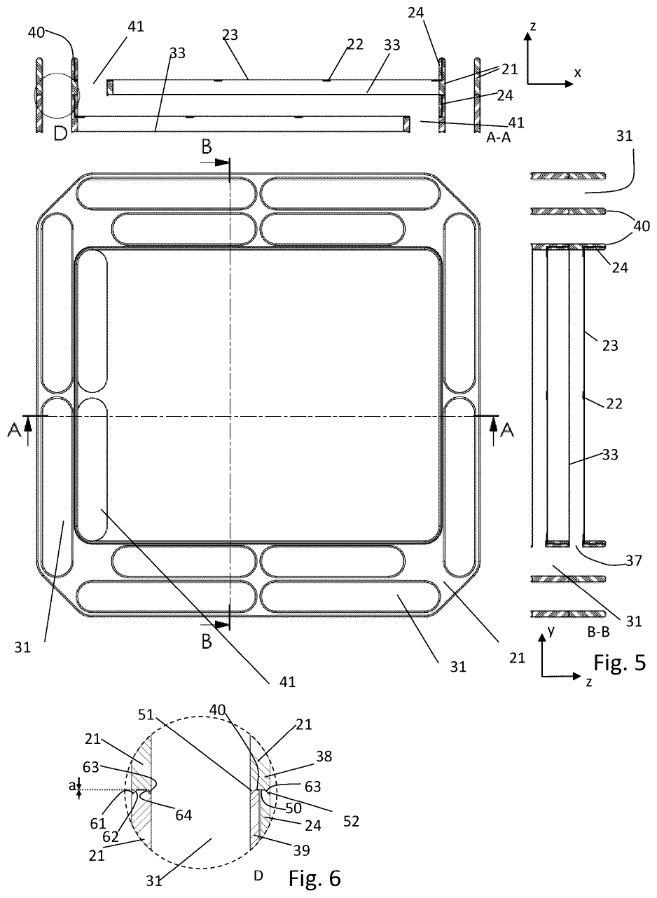

A sieve device 20 is shown in an exploded illustration in FIG. 3. FIG. 4 shows a view of two sectioned sieve devices 20 which are stacked on one another. FIG. 5 shows a view of the sieve devices 20 of FIG. 4 from above as well as sections through the planes A-A and B-B in a view from above, i.e. FIG. 5 shows a plan elevation, front elevation and a lateral elevation of the arrangement of FIG. 4. FIG. 6 shows detail D from the section A-A in FIG. 5.

A sieve frame 21 forms a mechanical carrier structure of the sieve device 20. An insert frame 22 (primary frame) carries the sieve 23. For example, the sieve 23 can be designed as a metallic foil with perforations as sieve holes as is represented in the Swiss patent application 000837/2022, wherein the foil is welded onto the—likewise metallic—insert frame 22

Apart from the sieve frame 21 and the insert frame 22 with the sieve 23 which is fastened thereto, the sieve device also includes a clamping frame 24 which fixedly holds the—flat—insert frame 22 and the sieve 23 relative to the sieve frame 21.

The sieve frame includes a circumferential side wall 30 and in this towards the sides in each case two rows or one row or no row of at least one through-channel 31, so that the side wall forms wall sections at the very outside, at the very inside and possibly between the through-channels 31. In the drawn embodiment example, two rows each with two through-channels 31 are each present at two opposite sides (in the plan elevation according to FIG. 5 at the top and the bottom), whereas the two other opposite sides each include one row with two through-channels 31. The arrangement of through-channels can vary from sieve device to sieve device, in order to lead fractions of the sieving product which are fed in through the feed conduits as well as separated by the sieves, in accordance with requirements.

The insert frame 22 includes an outer frame part 26 which forms a rectangle with rounded corners, as well as rods, over which the sieve 23 is spanned and which one can see in an indicated manner in FIG. 3. The frame elements of the outer frame part as well as the rods, over which the sieve is spanned, can each have rectangular or also other cross sections.

Per sieve device, a collection region forms below the sieve 23 and this is closed off to the bottom by a collection base 33 of the sieve frame 21. The collection region is each open to at least one side, in order to discharge fine shares of the sieving product which have gotten through the sieve (the so-called throughs) through a laterally arranged slot opening 37 which runs out into a through-channel 31. The collection region is closed to the other sides by a lower portion 38 of the circumferential side wall 30, said side wall being formed by the sieve frame. The other through-channels 31 of the upper sieve device which are represented in the figures serve as drop-channels, i.e. for the continued passage downwards of sieving product which comes from a sieve device which lies further to the top or from a sieving product inlet.

The throughs get from the through-channel 31 into which the slot opening 37 runs, either into a through-channel 31 (more precisely: a drop channel) of the sieve device lying therebelow, as is represented in the drawn configuration, or it gets onto the sieve of the sieve device which lies therebelow.

The following generally applies to through-channels 31: a through-channel 31 either runs out into an outlet conduit 7 (in particular this applies to the lowermost sieve device), into a through-channel 31 of the sieve device which lies therebelow or possibly of a drive module which is arranged between sieve devices 20, or the sieve of the sieve device lying therebelow extends to below the through-channel 31 so that the sieving product gets from the through-channel onto the sieve of the sieve device lying therebelow.

The sieve 23 and the insert frame include lateral sieve through-openings 41 which are present on the sieve plane and through which sieving product shares (the so-called refuse or overtails) which has not been sieved through the sieve can drop. The sieve frame is designed such that the collection base does not reach to below the sieve through-openings 41. In contrast, depending on the desired configuration, the refuse gets through the sieve through-openings—and under certain circumstances through a shortened, assigned through-channel below the sieve through-opening—either into a through-channel 31 of the sieve device lying therebelow, or, as is represented in the configuration of the present figures, onto the sieve 23 of this sieve device 2 which lies therebelow. In the shown example, by way of rotating the sieve frame by 90° or 270° one succeeds in the refuse not falling from the sieve through-opening 41 onto the next sieve which lies therebelow, but into a through-channel 31 (drop-channel). This makes sense for example if the sieving product has been completely sieved out. This refuse can then get from the sifter onto a further roller mill via drop-channels.

The sieve frame 21 forms a circumferential rest for the insert frame 22. The rest can be formed by a shoulder 34 where the collection region is closed off to the sides by a lower portion 38 of the circumferential side wall 30, whilst at other locations above the lateral slot opening 37 it can be formed by an inwardly projecting projection 35. The rest is uninterrupted along the circumferential line of the insert frame 22.

In embodiments, the sieve frame is at least partly metallic. In such embodiments, the collection base can be formed by a base sheet and the circumferential side wall can be constructed of several parts, with several wall elements, for example with an outer wall element which forms the outer wall surface, a lower inner wall element which forms the inner wall surface of the lower portion 38, an upper inner wall element which forms the inner wall surface of the upper portion 39 and several through-channel wall elements which surround the through-channels. A thermally insulating filling material can be arranged in the intermediate spaces between the wall elements. The shoulder 34 and the projection 35, i.e. the rest can be formed by an intermediate base.

The dimensions of the sieve frame 21 on the one hand and of the clamping frame 24 on the other hand are matched to one another such that the clamping frame fits precisely into the receiver which results within the upper portion of the circumferential side wall.

In particular, the dimensions of the sieve frame 21 and of the clamping frame 24 are matched to one another such that the inner surface of the lower portion 38 is flush with the inner surface of the clamping frame 24, as one can see for example in FIG. 5 (sections AA and BB) or also see well in FIG. 6.

Furthermore, the height of the clamping frame 24 is matched to the distance between the rest and the upper edge 40 of the circumferential side wall as well as to the thickness of the insert frame 22, so that the upper edge of the clamping frame 24 lies at the same height as the upper edge 40 of the circumferential side wall, so that the clamping frame 24 on stacking the sieve devices 20 acts and can be perceived as a part of the sieve frame 21.

In contrast to the state of the art, no seal is necessary where the insert frame 22 lies on the rest (shoulder 34, projections 35). This is due to the design of the sieve frame 21 with the circumferential (vertical) side wall 30, wherein the insert frame is inserted into a trough-like structure which is formed by the sieve frame. On account of this design, the sieving product can only escape past the sieve 23 and the sieve through-openings 41 if between the clamping frame 24 and the insert frame 22 is gets outwards, downwards along the outer edge of the insert frame 22 and then inwards again between the insert frame and the rest. This design acts in the manner of a labyrinth seal, which is also sufficiently efficient even if no separate seal with a sealing (for example elastic, elastically deformed) material is present at all, for example between the clamping frame and the insert frame.

In particular, in FIG. 6 one can see that the sieve devices 20 include an upper-side stack structure and a lower-side stack structure at horizontal positions (x-y positions) which correspond to one another, see the Cartesian coordinate system which is indicted in the upper and right panel of FIG. 5. If the sieve devices are stacked upon one another in the designated manner, then the lower-side stack structure of the respective upper sieve device lies on the upper-side stack structure of the lower sieve device.

The upper-side stack structure includes an outwardly descending first ramp 61, on which an inwardly descending second ramp 62 of the lower-side stack structure of the upper sieve device 20 lies. The outwardly descending first ramp 61 and the inwardly descending second ramp 62 are plane and parallel to one another in the represented embodiment example. They have an angle of between 25° and 65°, in particular between 30° and 50° to the horizontal.

“Inner” and “outer” are to be understood in relation to the sieve device as a whole, i.e. “inner” is the side of the wall which faces the sieve and the collection region, whereas “outer” is the opposite side, at the left in FIG. 6.

The upper and the lower stack structure are designed such that the first and the second ramp 61, 62 lie on one another in a force-transmitting manner. For this reason, generally no force-transmitting resting takes place upon the upper edge 40—there, the surface of the sieve frame runs horizontally in an extensive manner, in alternative embodiments also in a curved manner. In contrast, a distance a results between the upper edge 40 and the lower-side counter-surface 50, wherein the distance a under certain circumstances—depending on the manufacturing tolerances—can be very small and be 1-2 mm or even less.

In the represented embodiment example, the upper-side stack structure apart from the outwardly descending first ramp 61 also includes an upper-side, inwardly descending third ramp 63 and accordingly the lower-side stack structure includes a lower-side, outwardly descending fourth ramp 64. For this reason, the centring effect of the ramps also acts in a local manner, for each pair of a wall section of the upper sieve device with a wall section of the lower sieve device. The effect of this is that the stack structure is even quite stable when the walls only have a low thickness and accordingly are still slightly flexible.

On account of the through-channels 31, the sieve frames 21 depending on the configuration include several wall sections in the vertical section (sections A-A and B-B in FIG. 5 as well as FIG. 6). In the shown embodiment, two wall sections are each present for example on two sides, and three wall sections are present on the other two sides, corresponding to the two rows of through-channels. Given several wall sections per side, the represented stack structure is present at least at the respective outermost wall, and present for example at each wall. In the represented embodiment example, each wall includes a stack structure of the described type, which one can likewise see in FIG. 5 in the sections A-A and B-B as well as in FIG. 6.

Concerning the innermost wall section, the inwardly descending third ramp 63 is not formed by the sieve frame, but by clamping frame 24 which is shown at the right in FIG. 6.

The inwardly descending second ramp 62 of the lower-side stack structure and possibly its outwardly descending fourth ramp 64 in the represented embodiment example is/are each formed by a downwardly projecting outer and inner rib 51 and 52 respectively of the sieve frame 21, so that the walls of the sieve frame 21 are concave at the lower side. Accordingly, the walls of the sieve frame are convex at the upper side. This has the advantage that residues cannot accumulate in a groove (or other concave upper-side structure) in the course of time. A reverse configuration however is also not to be ruled out—also due to the very good sealing characteristics of the sieve frame. This means that it can also be the case that the outwardly descending first ramp of the upper-side stack structure is formed by an upwardly projecting rib and conversely the walls of the sieve frame are convex on the lower side.

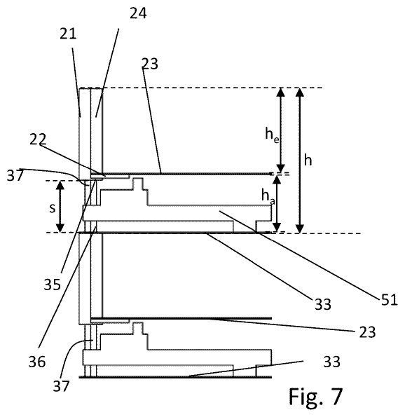

FIG. 7 shows a schematic cross section through two sieve devices which are stacked on one another, in an edge region (i.e. the representation is sectioned) and each with a schematically represented sieve cleaner 51 in the collection region. The height s of the lateral slot opening 37 is practically as large as the height ha of the collection region, i.e. as the distance between the collection base 33 and the sieve 23 (precisely: between the upper side of the collection base and the lower side of the sieve). For a desired lateral sieving product throughput away from the collection region through the lateral slot opening 37 into the through-channel, this permits the reduction of the height ha of the collection region, which leads to a reduction of the height of the sieve device as a whole (and therefore to the possibility, given a certain height of the plansifter, of providing more sieve devices or given a certain number of sieve devices of reducing the height of the plansifter) and/or the height s of the slot opening 37 to be increased, in order to achieve a highest throughput. Amongst other things, this advantage is made possible due to the insert frame being designed as a comparatively thin sheet, for example metal sheet with recesses for the surfaces over which the sieve is spanned as well as for the sieve through-openings. The insert frame can have a thickness for example of 5 mm at the most, in particular 4 mm at the most or 3 mm at the most and for example between 1 and 2.5 mm.

Since the slot opening 37 essentially has the complete height of the collection region and herewith also of possible sieve cleaners 51 which are present in the collection region, one can provide measures in order to prevent a sieve cleaner 51 from getting through the slot opening 37 and for example becoming jammed in the through-channel. In the represented embodiment example, the sieve frame includes restraining structures 36 in the form of rods which project from the collection base 33 and whose distances are selected such that no sieve cleaner can get through them. The restraining structures are arranged at least along the slot opening 37. In the shown embodiment example, there are furthermore also restraining structures 36 which segment the collection region, so that it is ensured that each segment retains its sieve cleaner or its sieve cleaners.

Sieve cleaners are optional: depending on the design of the collection region, they can also become superfluous and be done away, the more so due to the fact that as described the height s of the lateral slot opening can be particularly large, without the sieve device being too high.

A further optional feature of the sieve device can likewise be seen in FIG. 7: the collection base 33 is particularly thin in comparison to the state of the art by way of the collection base- and for example the complete sieve frame-being metallic, for example being manufactured of a sheet, for example steel sheet. The thickness of the collection base can be for example maximally 2.5 mm, in particular at the most 2 mm or at the most 1.5 mm or at the most 1 mm and for example between 0.3 and 0.8 mm.

This reduced thickness of the collection base—it can be realised independently of the reduced thickness of the insert frame—likewise contributes to the sieve device as a whole being able to be particularly flat given a certain height hₑ of the inlet region between the sieve 23 and the collection base of the sieve device lying thereabove, i.e. the height h of the sieve device can be particularly low—and/or the height hₑ of the inlet region (the “mouth”) can be larger than with the state of the art, in order to further increase the receiving capacity of the sieve device and herewith finally the efficiency.

In total, given a combination of these describe concepts, the height h of the sieve device can be particular low in comparison to the height s of the lateral slot opening and/or in comparison to the height hₑ of the inlet region. This permits an optimisation of the plansifter, wherein depending on the requirements, the number of sieve devices per plansifter can be increased (by way of the reduction of the height h in comparison with the state of the art) and/or the throughput per sieve device can be improved (increase of the height s of the slot and/or increase of the height hₑ of the inlet region). The optimisation can be carried out depending on the characteristics of the product to be sifted and one can take it characteristics into consideration.

1. A sieve device for a plansifter, comprising a sieve frame and an insert frame with a sieve which is fastened thereon, wherein the sieve frame comprises a circumferential side wall, and wherein the sieve frame comprises a rest, on which the insert frame lies, such that the circumferential side wall surrounds the sieve and extends to above the sieve such that the sieve lies below an upper edge of the circumferential side wall.

2. The sieve device according to claim 1, wherein the rest at least in regions is formed by shoulder of the circumferential side wall.

3. The sieve device according to claim 1, wherein the rest runs along a circumference of the insert frame without interruption.

4. The sieve device according to claim 1, wherein the sieve frame below the sieve forms a collection base, onto which sieving material which is sieved through the sieve gets, wherein the collection base-base is formed by a metal sheet and/or wherein the collection base has a thickness of at the most 2 mm.

5. The sieve device according to claim 1, wherein the sieve frame below the sieve forms a collection base, upon which sieving material which is sieved by the sieve gets, wherein the collection base is arranged at the very bottom on the sieve frame.

6. The sieve device according to claim 1, wherein a slot opening is formed in the circumferential side wall below the sieve, through which slot opening sieved-through sieving material which is present on the collection base can get into a through-channel, wherein a height(s) of the slot opening is at the most 20% or at the most 15% smaller than the distance between the collection base and the sieve.

7. The sieve device according to claim 1, comprising a plurality of restraining structures which project upwards from the collection base in order to limit the movement of sieve cleaners.

8. The sieve device according to claim 1, wherein the insert frame is metallic and/or has a thickness of at most 3 mm.

9. The sieve device according to claim 1, comprising a clamping frame which is arranged above the insert frame and within an upper portion of the circumferential side wall.

10. The sieve device according to claim 9, wherein the clamping frame at the upper side is flush with an upper edge of the circumferential wall of the sieve frame.

11. The sieve device according to claim 1, wherein the sieve is designed as a flat body with through-holes.

12. The sieve device according to claim 11, wherein the sieve is metallic.

13. The sieve device according to claim 1, wherein the sieve frame at the upper and lower side at positions corresponding to one another comprises an upper side and lower-side stack structure respectively, wherein the upper-side stack structure comprises a first ramp and the lower-side stack structure comprises a second ramp, wherein the first ramp and the second ramp are in contact with one another in a force-transmitting manner when a lower and an upper sieve device are stacked on one another.

14. The sieve device according to claim 1, wherein two rows of through-channels are formed on at least one side of the circumferential side wall.

15. The sieve device according to claim 1, wherein the circumferential side wall is formed by a plurality of sheet pieces, wherein a thermally insulating filling material is present in intermediate spaces between sheet surfaces.

16. A plansifter for fractionating ground cereal products for a cereal mill, comprising at least one stack with a plurality of sieve devices according to claim 1 as well as a sieving product inlet and a sieving product outlet, wherein the plansifter is further configured to bring the stack into oscillation movements, in order to encourage the at least partial passage of sieving product which is brought into the sieving product inlet, through the sieves of the sieve devices.
